(19) United States
(12) Patent Application Publication
(10) Pub. No.: US 2011/0107097 A1
(43) Pub. Date: May 5, 2011

(54) METHOD FOR ENCODED DATA EXCHANGE AND COMMUNICATION SYSTEM

(76) Inventors: Michael Braun, Munchen (DE); Anton Kargl, Munchen (DE); Bernd Meyer, Munchen (DE)

(21) Appl. No.: 12/993,840

(22) PCT Filed: Mar. 24, 2009
(86) PCT No.: PCT/EP09/53422

§ 371 Date: Jan. 13, 2011

(30) Foreign Application Priority Data
May 20, 2008 (EP) 08009277.8

(51) Int. Cl. H04L 9/32; H04L 9/00

(52) U.S. Cl. 713/168; 713/150

(57) ABSTRACT

In a system and method for encrypted data exchange between entities (users) of a communication system using cryptography based on elliptic curves, in response to a challenge of a first user a scalar multiplication is calculated by the second user, wherein only part of the result of the scalar multiplication is sent back as response to the first user.

### CROSS-REFERENCE TO RELATED APPLICATIONS

This application is a U.S. National Stage Application of International Application No. PCT/EP2009/053422 filed Mar. 24, 2009, which designates the United States of America, and claims priority to EP Application No. 08009277.8 filed May 20, 2008. The contents of which are hereby incorporated by reference in their entirety.

### TECHNICAL FIELD

The invention relates to a method for encrypted data exchange between entities (users) of a communication system and also to a communication system.

### BACKGROUND

The present invention lies in the field of communications technology and in particular in the field of contactless communication for the purpose of identification. Although applicable in principle to any communication systems, the present invention and the problems underlying it are explained hereinbelow with reference to what are termed RFID communication systems and their associated applications. RFID stands in this context for “Radio Frequency Identification”. For the general background to said RFID technology reference is made to the “RFID-Handbuch” (“RFID Handbook”) by Klaus Finkenzeller, Hansa-Verlag, third updated edition, 2002.

In RFID systems known today, an electromagnetic signal broadcast by a base station (or reading station or reader) is typically picked up by a passive transponder (or tag) which obtains from said signal the energy required in the transponder. In most RFID systems based on UHF or microwaves, in addition to this unidirectional transmission of energy there also takes place a typically bidirectional data communication on the basis of what is termed a challenge/response method. In this scheme the base station continuously transmits inquiry signals (data request, challenge) which are answered only when a corresponding transponder is located within the range of coverage of said base station. In this case the transponder located in the immediate environment of the base station responds with an answer signal (response). Such RFID transponders are used, for example, for identifying objects such as e.g. goods, documents and the like.

In contrast to a conventional wire-based form of data communication the data communication between the base station and a corresponding transponder is established virtually independently and to a certain extent in the background, without a human user having to be present at all. In other words the data communication is initiated as soon as an authenticated transponder is located within the range of coverage of the associated base station. Whereas, for example, when reading a data medium such as e.g. a floppy disk, a USB stick or similar, said medium has to be consciously brought into contact with a corresponding reader device by the user and in the case of a wired data communication the data communication likewise has to be consciously initiated by the user, this is not the case with RFID-based wireless data communication.

This has some significant advantages, e.g. for identification in the logistics field, in warehouses, etc. Conversely, this RFID-based data communication technology also has a number of disadvantages which need to be taken into account in many applications.

One such problem relates to the reading out of data contained in an RFID transponder by an unauthorized user (attacker), in particular when said data is security-critical data. For these reasons an RFID-based data communication system typically also includes a security mechanism which, for example, safeguards the data communication to the extent that a security code is modulated onto the transmit signal by the base station, which security code can then be decoded and evaluated by the transponders authorized to take part in the data communication. Following successful evaluation the transponder authorized to take part in the data communication sends a response signal that likewise contains a security code back to the base station, which security code can then be evaluated in the base station in order to authenticate the transponder. By means of said authentication it is ensured in the base station that no unauthorized user can couple into the data communication unnoticed and consequently read out security-critical data.

An essential boundary condition in transponder-based data communication is that data communication between base station and transponder shall take place as simply and rapidly as possible. The reason for this is firstly that the transponder typically possesses only limited resources, in other words on the one hand it has limited energy resources and on the other hand limited memory and computing resources, so that at the time of authentication typically it is beneficial for the smallest possible data volumes to be evaluated and authenticated. Secondly, said authentication should also be performed as quickly as possible, since in particular with dynamic RFID-based data communication systems the transponder that is to be authenticated is very often located in the range of coverage of the respective base station only for a short time span. Within said short time span not only must a data communications connection be set up and authenticated first, but then the data exchange must also take place.

In order to safeguard the data communication between base station and transponder a cryptographically protected data communication, for example, can be performed on the basis of asymmetric cryptographic methods. It is essential for said cryptographic encryption methods that a reversal, that is to say determining the private key from the public key, will scarcely be manageable in reasonable time with the computing capacities available.

It has proved advantageous to employ cryptographic encryption algorithms based on elliptic curves, since these provide a high level of security with short key lengths. Such cryptographic encryption methods based on elliptic curves are very efficient, in particular owing to the fact that with said methods, in contrast to other known cryptographic techniques, no method of attack using a sub-exponential runtime is known. To put it another way, this means that the security gain per bit of the security parameters used in methods based on elliptic curves is higher and therefore significantly shorter key lengths can be used for practical applications. Consequently cryptographic methods based on elliptic curves are more powerful and require a smaller bandwidth for transmitting the system parameters than other cryptographic methods while at the same time providing a comparable degree of attainable security.

The cryptographic methods thus represent a compromise between a level of security to be expected and the computational overhead necessary for the encryption of data.

It is demonstrated in the German patent application DE 101 61 138 A1 that it is possible to determine the scalar multiple of a point already on the basis of the X coordinate of said point alone, without reference to the Y coordinate. Corresponding computational rules for arbitrary bodies are also described in this publication. By this means it is possible to achieve much more efficient implementations of the point arithmetic, for example a Montgomery ladder, for the scalar multiplications, a smaller number of body multiplications per point addition, and a smaller number of registers for the point representation of the intermediate results.

The European patent application EP 1 675 300 A1 describes an authentication method between entities or users of a communication system wherein use is made of bilinear mappings for cryptographic encryption of the data communication between the users of the communication system. Said cryptographically secured data communication takes place on the basis of elliptic curves using a challenge-response procedure.

A new attack on cryptographic methods whose security is based on the discrete logarithm problem in a finite group is described in the publication titled “The Static Diffie-Hellman Problem”, by Daniel R. L. Brown and Robert P. Gallant of Jun. 23, 2005. This is applicable in particular to elliptic curves. The attack described can be efficiently executed when an attacker has a device available (referred to in the literature as an “oracle”) that contains a secret scalar s and, when an arbitrary point U, is input returns the result of the calculation T=sU, i.e. the result point T of the scalar multiplication, to the attacker. The attack requires in particular a sequence of points P0, P1, P2, . . . , Pn on the elliptic curve, where Pᵢ=sPᵢ₋₁ applies. This attacker scenario is given in particular in the case of the method described in the German patent application DE 101 61 138 A1, which is suitable in particular for applications on systems with limited memory space and low available computing capacity.

### SUMMARY

Against this background, according to various embodiments, a means of authentication for wireless data communication can be provided which cannot be compromised by the above-disclosed attack. According to other embodiments, a means of authentication for wireless data communication for can be provided which in particular a smaller computational overhead is required while security is maintained at the same high level, and which in particular is also fast.

According to an embodiment, in a method for encrypted data exchange between users of a communication system using cryptography based on elliptic curves, in response to a challenge of a first user a result of a first scalar multiplication is calculated by the second user,wherein a function value is determined from the result of the scalar multiplication with the aid of a non-infective mapping so that the function value permits no unequivocal deduction to be made about the result, and wherein the function value is sent back as the response to the first user.

According to a further embodiment, a part of the result of the scalar multiplication can be determined as the function value and sent back as the response to the first user, the response may contain an x coordinate of a point on the elliptic curve, and only a part of the x coordinate contained in the response may be sent. According to a further embodiment, a part of the result of the scalar multiplication can be determined as the function value and sent back as the response to the first user, the response may contain a y coordinate of a point on the elliptic curve, and only a part of the y coordinate contained in the response may be sent. According to a further embodiment, the challenge may contain the x coordinate of a point on the elliptic curve. According to a further embodiment, the coordinates can be present in binary form. According to a further embodiment, the x or y coordinate of the point on the elliptic curve contained in the challenge and/or the response may be present in a projective representation. According to a further embodiment, the coordinate of the point in binary representation can be a number containing a first and a second value which can be represented arrayed in series in a binary representation. According to a further embodiment, only part of the bits of at least one of the two values can be sent back. According to a further embodiment, half of the bits of at least one of the two values can be sent back. According to a further embodiment, referred to the MSB bit, an upper bit range of the bits, in particular an upper half of the bits of at least one of the two values, can be sent back. According to a further embodiment, the first user may check the response received from the second user to verify its authenticity. According to a further embodiment, the first user may check whether the data contained in the response and the data of the result of a second scalar multiplication are coordinates of the same point. According to a further embodiment, the first user may compare the data contained in the response with a result of a second scalar multiplication, and in that the first user accepts the second user as authentic provided corresponding data of the response and of the result of the second scalar multiplication match one another. According to a further embodiment, only those parts of the result of the second scalar multiplication that correspond to the part of the response sent by the second user to the first user may be used for the comparison of the data of the response with the result of the second scalar multiplication. According to a further embodiment, the part of the result of the first scalar multiplication that is not transmitted back as response represents a randomly generated result which is known to at least one of the two users, preferably to both users, and which can be used as a secret key in subsequent method steps. According to a further embodiment, the method can be an authentication method based on a challenge-response procedure for authenticating the second user to the first user and/or vice versa. According to a further embodiment, the challenge of the first user can be independent of the key of the second user. According to a further embodiment, an elliptic curve suitable for cryptographic methods and an affine x coordinate of a base point of the elliptic curve and a public key for signature verification can be provided as system parameters of the communication system. According to a further embodiment, only a key known to the second user and a certificate of the second user may be provided as parameters of the second user. According to a further embodiment, the certificate of the second user can be transmitted together with the response by the second user, a validity check of said certificate being performed in the first user using a public key known to both users.

According to another embodiment, a communication system for authenticating the users of the communication system may use a cryptographic method as described above.

According to a further embodiment of the system, a first user and at least one second user may be provided, connected to one another by a data communications link, the first and second user each having an authentication module for authentication purposes. According to a further embodiment of the system, the authentication module of a respective user may have a computing device that is provided for performing calculations, checks and authentications within the respective authentication module. According to a further embodiment of the system, each user has a memory in which the system parameters and the parameters individually associated with said user are stored. According to a further embodiment of the system, the first and second users may be communication entities of the communication system, in particular of a communication system embodied as an RFID system. According to a further embodiment of the system, the first user may be a base station and the second user may be a transponder, in particular a passive or semi-passive or active transponder.

### BRIEF DESCRIPTION OF THE DRAWINGS

The invention is explained in more detail below with reference to exemplary embodiments depicted in figures of the drawing, in which:

FIGS. 1a, 1b show examples of an elliptic curve;

FIG. 2 shows an example of an addition using an elliptic curve;

FIG. 3 shows with the aid of a block diagram the structure of a communication system according to an embodiment;

FIG. 4 is a flowchart to illustrate the authentication method based on elliptic curves; and

FIGS. 5a-5c show schematic representations serving to explain the method for reducing the response data and the method for comparing said data-reduced response data with calculated response data.

Unless explicitly stated otherwise, identical and functionally identical elements, features and signals are labeled by the same reference signs in all the figures of the drawing.

### DETAILED DESCRIPTION

Accordingly there is provided:

A method for encrypted data exchange between users (2, 3) of a communication system (1) using cryptography based on elliptic curves, wherein in response to a challenge of a first user (2) a result of a first scalar multiplication is calculated by the second user (3). A function value is determined from the result of the scalar multiplication with the aid of a non-injective mapping such that the function value permits no unequivocal deduction to be made about the result. Finally the determined function value is sent back as response to the first user (2).

A communication system for authenticating the users of the communication system using an encryption method according to various embodiments.

The concept underlying the various embodiments consists in supplying the data that is to be sent back during the authentication process between two users of a communication system, and in particular when a response signal is sent back by a transponder to a base station, to a non-infective mapping so that the function values determined in such a way permit no unequivocal deduction to be made about the result. The fact that, for example, the full x coordinate of the result point is no longer output, but rather a function value calculated therefrom which no longer allows an unequivocal reconstruction of the x coordinate, means that the iteration of the scalar multiplication necessary for the attack described using the oracle is no longer possible and the attack is repelled.

In a further embodiment, during the authentication process between two users of a communication system, and in particular when a response signal is sent back by a transponder to a base station, said data to be transmitted back is reduced by means of the non-infective mapping.

During the authentication of a transponder by a base station use is typically made of an authentication protocol based on a challenge-response procedure. According to said authentication protocol the transponder for example calculates a scalar multiplication in response to a challenge from the base station and as the result obtains an x coordinate in an affine representation. With methods known from the prior art, when the response was transmitted back the full affine x coordinate was sent back by the transponder as the response signal to the base station.

The knowledge on which various embodiments are based thus resides in the fact that for the transmission of the affine representation of the x coordinate it is not necessary for the full value to be sent back by the transponder to the base station. Rather, it suffices if the value is sent back at least partially. Even with this quasi incomplete response the base station is then still able to carry out an authentication with a relatively high degree of security.

In a further embodiment, in response to a challenge of the base station the transponder calculates for example a scalar multiplication and obtains as the result an x coordinate in a projective representation. Said projective representation contains two values (X, Z) which can be represented arrayed in series in a binary representation. With methods known from the prior art, when transmitting back the response the transponder sent back both values, i.e. the pair (X, Z) of the x coordinate, as a response signal to the base station.

The knowledge on which the various embodiments are based thus resides in the fact that for the transmission of the projective representation of the x coordinate it is not necessary for the transponder to send back both values to the base station. Rather, it suffices if only one of these two values is sent back in full and the second value in each case is sent back at least partially. Even with this quasi incomplete response the base station is then still able to carry out an authentication with a relatively high degree of security.

The particular advantage in both embodiments presented lies in the fact that by this means the response data transmitted back by the transponder can be reduced, thereby shrinking the volume of response data requiring to be transmitted for the authentication as a whole. As a result the transponder requires less time for the return transmission, the authentication and the computing operations associated therewith. Furthermore, the static Diffie-Hellman attack is repelled in these embodiment variants too, since the full x coordinate of the result point is no longer output in affine or projective representation, and consequently the iteration of the scalar multiplication necessary for the described attack using the oracle is no longer possible. Taken as a whole, therefore, the entire authentication method can be made significantly simpler and also faster, without this being attended by a loss in security during the authentication.

For example, the transponder transmits only part of the value, for example a half, of the affinely represented x coordinate or only part of one of the two values of the projectively represented x coordinate. According to various embodiments this is realized in that, for example, only the upper part or, as the case may be, the upper half or alternatively the lower part or, as the case may be, the lower half of the correspondingly calculated value of the x coordinate is transmitted back. The base station then checks whether said part or half of the tallies with the corresponding part or half of the value corresponding to said calculated value. Only if the part or half of the bits are identical, will the transponder sending the response data be accepted as authentic on the part of the base station.

The authentication method according to various embodiments with the variant of data reduction in certain applications of the transponder in which the transponder transmits back projectively represented coordinates as response has various advantages:

The number of bits of the x coordinate that are to be transmitted in the projective representation is reduced significantly. In the above-mentioned case, in which only half of the bits of one of the two values are transmitted, the total volume of data to be transmitted is then reduced by a half in the affine case and by a quarter in the projective case.

In many applications, such as in the authentication protocol disclosed in the present patent application for example, the data reduction causes only a negligible reduction in the level of security. It is a well-known result of cryptography that an elliptic curve over a finite body GF (2^{d}) that is suitable for cryptographic applications only affords a security of 2^{d/2}. In other words, although elements of the body having a length of d bits are used, the security of this type of authentication using a public key corresponds only to a key length of d/2. Thus, from the perspective of an unauthorized user, it is just as difficult to breach the authentication method and thereby gain access to the secret key of the transponder as it is in the above-described authentication method according to various embodiments with reduced data volume to provide a valid response during the return transmission of the response. Depending on the specific application case and the security requirements specified or required therefor it is possible to reduce the number of bits of the x coordinate partially transmitted by the transponder to the base station even further.

The untransmitted bits represent a randomly generated secret which is known only to the transponder and the base station taking part in the data communication. Said untransmitted bits can be used for example as a key in subsequent protocol steps of the authentication method according to various embodiments. This means that in the authentication method according to various embodiments with data reduction through only partial transmission of x coordinates the protocol for (unilateral) authentication is expanded into a protocol for (unilateral) authentication with key agreement.

In a variant of the authentication method according to various embodiments it is possible, provided the transponder can perform divisions in the finite body and thus calculate the affine representation of the coordinate of the response, to apply the authentication method in the manner described also to the affine value. In this case the number of bits to be transmitted is likewise reduced significantly, typically to half the number of bits requiring to be transmitted.

Further embodiments and developments will emerge from the the description in conjunction with the figures of the drawing.

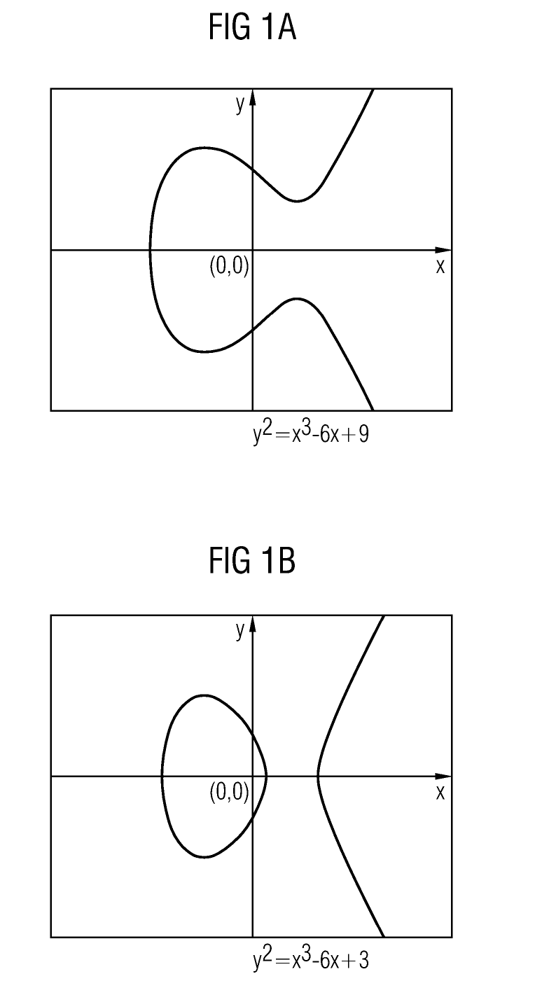

The authentication method according to various embodiments has a new security protocol which is based on an arithmetic for elliptic curves. Before the authentication method according to various embodiments is described, therefore, the most important properties of elliptic curves will first be explained with reference to FIGS. 1a and 1b.

An elliptic curve over a finite body (Galois field) GF (2^{d}) is the zero set of the cubic equation

y²+xy=y^{<3>}+ax²+b (1)

where x and y in this case denote variables and the coefficients a and b (where b≠0) denote coefficients in the Galois field GF (2^{d}).

FIG. 1a and FIG. 1b show two elliptic curves over the real numbers by way of example.

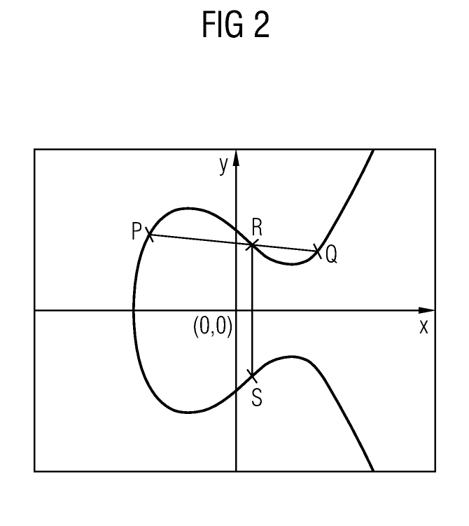

Adding an infinitely distant point as a neutral element, this zero set forms an additive group whose group law can be interpreted geometrically at least in the case of elliptic curves over the real bodies. Such an additive group consists of a number set and an addition (group operation). There also exists in this group a neutral element which when added to a number from the number set does not change its value (the zero, for example). For each value of the number set there also exists an inverse element, such that when the corresponding value is added to the inverse element the neutral element is obtained. Important in this case are two results from the algebraic geometry (see FIG. 2):

Each straight line intersects an elliptic curve at three points that are not necessarily different from one another. At each two not necessarily different points a third point can be calculated, with the result that the sum of the three points represents the neutral element. Supposing P and Q (where P≠−Q) are two points and g is the straight line through said points P, Q, then said straight line g intersects the elliptic curve at a third point R. By mirroring R at the X axis one obtains S=P+Q. For the case P=−Q the rise of g is infinite and the third intersection point R is the infinitely distant point.

Scalar multiplication on elliptic curves is defined analogously to the definition of scalar multiplication in vector spaces. Let P be a point on an elliptic curve and k be a natural number. The scalar multiplication k*P corresponds to a k-times addition of P to itself. This scalar multiplication k*P forms the essential building block in cryptographic systems based on elliptic curves. With cryptographically strong elliptic curves the scalar multiplication represents a one-way function, in other words it can be calculated in polynomial time, but according to the present state of the art in research and technology can only be inverted in exponential time. An efficient algorithmic reconstruction of the scalar is therefore difficult to imagine. This one-way function forms the foundation for cryptographic authentication methods based on elliptic curves.

A known method for implementing such scalar multiplications based on elliptic curves is what is referred to as the Montgomery ladder or Montgomery algorithm. The Montgomery ladder can be implemented in such a form that only the x coordinate of P and exclusively additions and multiplications in the Galois field GF (2^{d}) are used in order to calculate the x coordinate of a scalar multiple of a point P. No complex inversions are necessary here. The below-described bilateral authentication method according to various embodiments is based on said Montgomery algorithm.

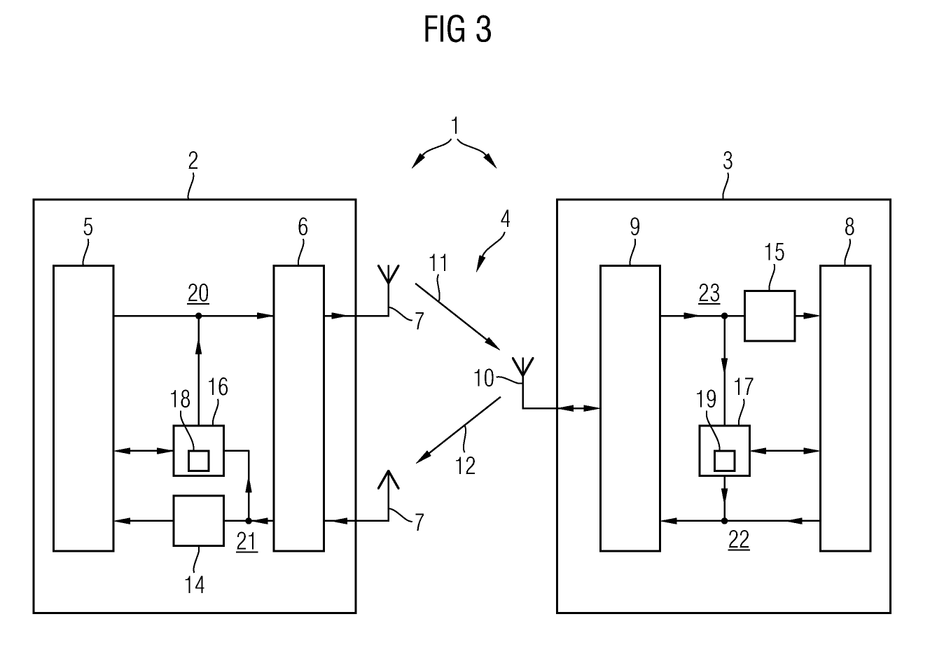

Before the bilateral authentication method according to various embodiments is described, the basic structure of a communication system according to various embodiments will first be explained below with reference to the block diagram shown in FIG. 3.

A communication system, for example an RFID communication system, is designated by reference sign 1 in FIG. 3. The RFID communication system 1 contains a first user (base station 2) and at least one second user (transponder 3). Base station 2 and transponder 3 are connected for purposes of bidirectional communication via a wireless communications link 4. The communication system 1 may be embodied for example as a so-called master-slave communication system 1, the base station 2 for example acting as master and the transponder or transponders 3 for example acting as a slave in each case.

The base station 2 includes a control device 5, a transmitting/receiving device 6, and a transmit/receive antenna 7. In the same way the transponder also includes a control device 8, a transmitting/receiving device 9, and a common transmit/receive antenna 10.

The transmit/receive antennas 7, 10 can be embodied as inductive coil antennas or as dipole antennas.

The flow of the data communication is controlled in the respective control devices 5, 8. Typically, said control device includes for this purpose a computing device (arithmetic logic unit, CPU) in which the computing operations, in particular for the authentication, are performed. The control devices 5, 8 may be embodied for example as a program-controlled device, such as a microcontroller or microprocessor for example, or alternatively be implemented in hardwired logic circuitry.

The control device 5 of the base station 2 is configured for sending radio-frequency carrier signals 11 via the antenna 7 to the antenna 10 of the transponder 3. In the same way the control device 8 and the transmitting/receiving device 9 of the transponder 3 are configured for sending back, in response to the transmitted carrier signals 11, corresponding response signals 12 to the base station 2.

The base station 2 additionally has an evaluation device 14. Said evaluation device 14 is disposed in the receive path 21 of the base station 2 and connected downstream of the receiver of the transmitting/receiving device 6. In the same way the transponder 3 also has an evaluation device 15 in the receive path 23 of the transponder 3. The evaluation of the received data of a data communication is performed in the respective evaluation devices 14, 15.

According to various embodiments both the base station 2 and the transponder 3 thus have an authentication module 16, 17 disposed between the respective transmitting/receiving device 6, 9 and control device 5, 8 of the base station 2 and transponder 3, respectively. Said authentication modules 16, 17 are in this example embodied as separate modules. Preferably, however, a respective authentication module 16, 17 is part of the respective control device 5, 8.

An authentication module 16, 17 also has a memory 18, 19 in which are stored, for example, data, keys or the like that are required for the authentication or need to be buffered. The memories 18, 19 typically contain a RAM memory in which, for example, computational results are stored. In addition or alternatively said memories 18, 19 may also be a nonvolatile memory, such as e.g. an EEPROM or a flash memory, in which system parameters, parameters of the different communication users, such as e.g. a user-specific private key, a public key, a user-specific certificate or the like, are stored.

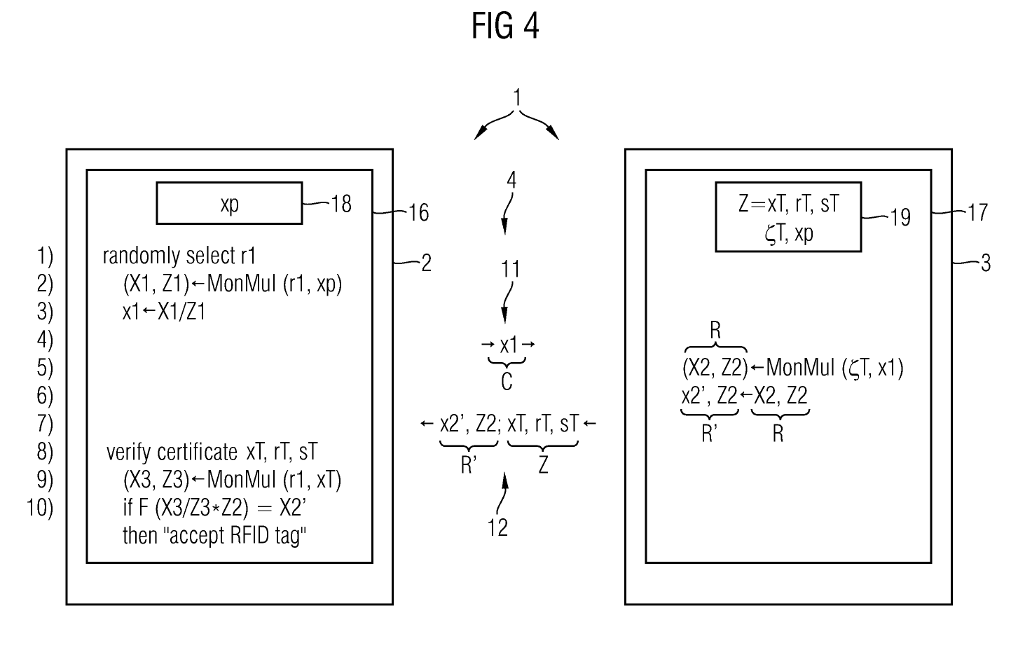

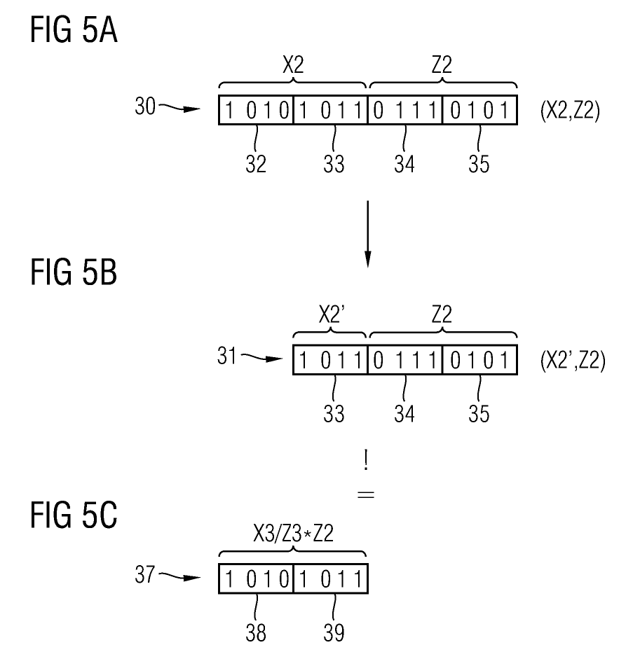

The principle of the authentication method (or authentication protocol) according to various embodiments is explained by way of example with reference to the schematic representations in FIGS. 4 and 5.

FIG. 4 shows a schematic representation of the base station 2 and the transponder 3 of the communication system 1, in that case only the authentication modules 16, 17 and the memory devices 18, 19 being shown inside said devices 2, 3. Let it be assumed that public keys are stored in the memory device 18 on the base station side and that the transponder's certificate, the transponder-side secret key, and where applicable the public key are stored in the memory device 19 of the transponder 3.

An example of the authentication method according to various embodiments based on elliptic curves is described below with reference to the flowchart in FIG. 4.

The following parameters are predefined as system parameters, i.e. as parameters that are valid for the entire communication system 1 and hence for the entire authentication.
A suitable elliptic curve is predefined.
xp denotes an affine x coordinate of the base point P on the elliptic curve.
xS denotes a public key, i.e. a key known to the base station and the transponder for signature verification purposes.

The following parameters are provided for the transponder 3:
ξT denotes the transponder-side secret key, which the base station 2 therefore does not know.
xT,rT,sT denote the certificate Z of the transponder 2, where xT denotes the public key (affine x coordinate of the point T=ξT*P) and rT,sT denote the signature of xT, verifiable with the public key xS.

The authentication method shown in FIG. 4 is performed as follows:

In steps 1)-3) the base station 2 generates the challenge C=x1 (C=Challenge). For that purpose a value r1 is chosen randomly. From said value r1 and the system parameter xp the base station 2 then calculates the challenge (X1, Z1), which represents the projective x coordinate of the point P1 (P1=r1*P). From these two values X1, Z1 the affinely represented x coordinate x1 is calculated as a challenge by means of a division. Said challenge x1 represents the x coordinate of the point P1=r1*P for a random scalar.

The base station 2 sends said challenge C=x1 to the transponder 3 in step 4).

A calculation of the response R (R=Response) is carried out in step 5). For that purpose the transponder 3 calculates the corresponding response data R=(X2,Z2) to the challenge x1, which response data represents the projective x coordinate of the point P2=ξT*P1=ξT*(r1*P).

In step 6) the response data R=(X2,Z2) generated by the transponder 3 and representing a randomly chosen projective representation of the x coordinate of the point P2 is reduced using a non-infective transformation to R′=(X2′,Z2). According to various embodiments a data reduction is therefore performed for one of these two values (X2,Z2) in method step 6).

In step 7) the response data R′=(X2′,Z2) generated by the transponder 3 is sent back to the base station 2 together with the certificate Z=xT,rT,sT of the transponder 3.

In step 8) the base station 2 checks the certificate Z=xT,rT,sT of the transponder 3. If the certificate Z is not valid, the base station 2 rejects the transponder 3 as not authentic.

In steps 9) and 10) the base station 2 checks the response of the transponder 3. The base station 2 calculates the calculated projective x coordinate (X3,Z3) of the point P3=r1*xT=r1*(ξT*P) and in the process checks whether the data (X2′,Z2) transmitted by the transponder 3 can be projective coordinates of the same point with the data (X3,Z3) generated in the base station 2. This is the case precisely when the following applies to the results of the scalar multiplications:

F(Z2*X3/Z3)=X2′,

where F represents the same non-infective mapping which the transponder 3 used in step 6) for calculating the response data R′=(X2′, Z2). In the exemplary embodiment described a data reduction is performed for that purpose in the same way on the calculated value Z2*X3/Z3, as took place in the transponder 3) in step 6).

If this relation holds true, the transponder 3 is authentic. If this is not the case, the base station 2 rejects the transponder 3 sending the response data R′ as not authentic.

What is important here is that the generation of the challenge C and the response R, R′ and the corresponding certificates Z are predefined in such a way that it is possible to perform the authentication protocol based on elliptic curves over the Galois field GF (2^{d}).

In methods known in the prior art the entire x coordinate (X2, Z2) of the point P2 was transmitted back to the base station, i.e. both values X2,Z2 of the response R for said x coordinate were transmitted back in full. When checking the response R the base station 2 was able to dispense with the use of the non-infective transformation for the data reduction and the relation necessary for the check took the form X2*Z3=X3*X2. Thus, step 7) followed on immediately after method step 5). According to various embodiments an additional method step 6) is now provided between steps 5) and 7). This additional method step 6) designates a data reduction step. In this method step 6) the response data R=(X2,Z2) generated by the transponder 3 and representing a randomly chosen projective representation of the x coordinate of the point P2 is reduced through application of a non-infective transformation. According to various embodiments a data reduction is therefore performed here in the case of one of these two values (X2,Z2) in method step 6).

In the exemplary embodiment shown in FIG. 5 let it be assumed that a data reduction is performed in the case of the first value X2 of the projective representation of the x coordinate (X2,Z2), such that the x coordinate now has the two values (X2′,Z2) and X2′ has data-reduced contents compared with the value X2. Said data-reduced response R′=(X2′,Z2) is then sent by the transponder 3 in method step 7) to the base station 2 together with the certificate Z of the transponder 3.

It is self-evident that instead of a data reduction of the first value X2 of the x coordinate a data reduction of the second value Z2 in each case can also be performed in addition or alternatively.

The base station 2 next checks whether the number (X3,Z3) calculated in the base station 2 tallies with the response R′ sent by the transponder 3. However, since this response R′=(X2′,Z2) is not complete, but is present in data-reduced form, only the corresponding part of the term X3*Z2/Z3 which is obtained through application of the non-infective transformation is checked with the component of the response X2′. In the exemplary embodiment, the transponder 3 is accepted as authentic by the base station 2 only if this corresponding part of the number X3*Z2/Z3 tallies with X2′.

This method for data reduction and the corresponding method for comparing said data-reduced values are explained briefly below with reference to schematic representations shown in FIGS. 5a-5c:

FIG. 5a shows the x coordinate or, as the case may be, number 30 generated at method step 5). FIG. 5a first illustrates the structure of the number 30. Said number 30 contains two numeric values X2, Z2. Said x coordinate 30 and at the same time its values X2, Z2 are represented here in binary coding. Let it be assumed that each of the two values X2, Z2 is eight bits wide and said two eight-bit-wide values X2, Z2 are arranged immediately next to each other. The entire x coordinate 30 is therefore 16 bits wide. In the example shown the value X2 of said number 30 is subdivided into an upper four-bit-wide half 32 with the bit sequence 1010 and a lower four-bit-wide half 33 with the bit sequence 1011. The value Z2 of the number 30 also has two bit halves 34, 35 with the bit sequences 0111 and 0101.

In method step 6) a data-reduced number 31 having the values X2′, Z2 is generated from the number 30. To that end the upper half 32 of the value X2, for example, is ignored for the generation of the data-reduced number 31, i.e. the data-reduced number 31 has only the lower half 33 of the value X2 as well as the full value Z2. After the data reduction at step 6) the data-reduced x coordinate 31 contains only the lower half 33 of the value X2 as well as both halves 34, 35 of the value Z2. The upper half 32 of the value X2 is now no longer part of the data-reduced x coordinate 31 and consequently is also not transmitted back to the base station 2 by the transponder 3.

In the example shown in FIG. 5 the upper half 32 was ignored for the data-reduced x coordinate 31. It would of course also be conceivable here to ignore the lower half 33 of the value X2 or one of the two halves 34, 35 of the value Z2. Furthermore, precisely half 32 of the value X2 and hence four bits of the eight-bit contents of the value X2 were ignored in each case. It would be conceivable here to ignore an arbitrary non-zero data reduction of the value X2, i.e. it would also be conceivable, for example, to ignore only one bit or up to seven bits of the value X2 for the generation of the data-reduced x coordinate. It would also be conceivable to apply further non-infective mappings of elements of the finite body which cannot be realized in a simple manner by ignoring bits of one of the values of the projective representation.

Method step 10) will now be described with reference to FIG. 5c. In the authenticity check, the number 37 is first calculated using the formula X3*Z2/Z3 from the values X3, Z3 and the value Z3 contained in the response of the transponder 3. The number 37 is in turn subdivided into two halves, the numbers 38 and 39. The authenticity check is now performed, not by comparing the two number pairs 32,33 and 38,39, but simply by comparing the number 33 with the number 39.

In the present case shown in FIG. 5 the bit contents of the section 33 are identical to the respective bit contents of the section 39, with the result that in this case the base station 2 identifies the corresponding transponder 3 which sent the data-reduced number 31 as authentic. This is done even though the upper section 32 of the value X2 is not compared with the upper section 38 of the corresponding value X3*Z2/Z3. This is based on the knowledge that in particular with very large bit widths of the numbers to be compared it is already sufficient to transmit only part of these values and perform the comparison with the corresponding part. If said sections compared with each other are a match, then it can be assumed with very great probability that the corresponding number pairs 32,33 and 38,39 are identical.

Although the present invention has been described in the foregoing with reference to various embodiments, it is not limited thereto, but can be modified in a multiplicity of different ways.

Thus, the invention shall in particular not be limited exclusively to RFID systems, but can also be extended to item identification, for example. Often such parts do not have to be identified uniquely. In this case it is frequently also sufficient to be able, for example, to rule out the presence of a defective part. This is generally also referred to as non-unique identification. During operation of the transponder in this context it has the function of a sensor. The invention therefore also relates explicitly to such sensors in which communication is carried out for the purpose of reading and writing data of a data medium or, as the case may be, of a sensor.

The invention is also intended to relate to any data communication systems that are not necessarily RFID systems and that also are not necessarily embodied as wireless systems.

In FIGS. 3 and 4 the structure of the RFID system and in particular of the transponder and the base station was shown intentionally in greatly simplified form for the sake of better clarity. It is self-evident that the base station and the corresponding transponder can also include the functional units required for data communication between base station and transponder, such as demodulator, modulator, power supply, synchronization device, decoder, and the like.

In FIGS. 3 and 4 a distinction was made in each case between control device, evaluation device and authentication module. It is self-evident that said devices or parts thereof can be e.g. a constituent part of the control device or can also be embodied separately therefrom.

Let it also be pointed out that both the base station and the transponder can have a single transmitting/receiving device and an associated transmit/receive antenna. It would of course also be conceivable for the base station and/or the transponder to have separate transmitting/receiving devices and in particular a transmit antenna and a receive antenna separate therefrom.

The data communication system and data communication method described hereintofore were described on the basis of the “reader talks first” principle. The “tag talks first” principle would of course also be conceivable, whereby the base station initially waits for a challenge from a transponder. However, this second-cited principle has a poorer response time, so the “reader talks first” principle is preferably employed in particular in modern, so-called “long-range” data communication systems, such as are used for example for RFID.

It is self-evident that the authentication method according to various embodiments described with reference to FIG. 5 is to be understood merely as exemplary. It is obvious that the individual method steps and mathematical operations applied there could also be varied and modified within the scope of the invention, for example by means of functionally identical or alternative method steps.

Let it further be pointed out that the specified numbers and bit widths cited are to be understood purely as exemplary and that the invention is in any event not to be limited thereto. In particular it would also be conceivable to use a greater or smaller bit width for the respective values. Furthermore the various sections of a value also are not required to have the same bit width, but can be different. The same applies to the bit width of the two values X, Z of a particular projective x coordinate.

A new attack on cryptographic methods whose security is based on the discrete logarithm problem in a finite group is described in the publication titled “The Static Diffie-Hellman Problem”, by Daniel R. L. Brown and Robert P. Gallant of Jun. 23, 2005. This is applicable in particular to elliptic curves. The attack described can be efficiently executed when an attacker has a device available (referred to in the literature as an “oracle”) that contains a secret scalar s and, when an arbitrary point U is input, returns the result of the calculation T=sU, i.e. the result point T of the scalar multiplication, to the attacker. The attack requires in particular a sequence of points P0, P1, P2, . . . , Pn on the elliptic curve, where Pᵢ=sPᵢ₋₁ applies. This attacker scenario is given in particular in the case of the RFID tag described. The RFID tag described is precisely the technical implementation of such an oracle.

In the authentication protocol of the described RFID tag, the tag calculates a scalar multiplication and obtains as the result the x coordinate in a randomly chosen projective representation (X2,Z2). In the prior art the whole pair (X2,Z2) was sent back as the response to the terminal. The security of the authentication protocol versus the static Diffie-Hellman attack was assured until now through the properties of the elliptic curves used. In order to repel the static Diffie-Hellman attack, elliptic curves were therefore used whose orders contain what are termed strong prime divisors. The cryptographic applications were performed within these cyclic subgroups, generated by strong prime divisors, of the finite point groups.

Advantageously, the method according to various embodiments is suitable for repelling “static Diffie-Hellman attacks” of said kind. As in the above-described exemplary embodiment, the RFID tag returns only a part of the calculated bits of one of the values X2, Z2. The terminal then checks whether the corresponding bits of the number X3*Z2/Z3 tally with the returned bits. If the bits are identical, the RFID tag is accepted as authentic. On the one hand this reduces the number of bits of the response (X2,Z2) that are to be transmitted, and on the other hand prevents the affine x coordinate of the result from being reconstructed and used for a new invocation of the scalar multiplication in order to enable the above-described sequence of points P0, P1, P2, . . . , Pn to be generated for mounting an attack.

Because the full x coordinate of the result point is no longer output, the iteration of the scalar multiplication necessary for the attack described using the oracle is no longer possible and the attack is repelled. If an attacker henceforth only obtains a part of the x coordinate of the result point, there are generally very many values which can occur as the x coordinate of a point and nonetheless match the fragment known to the attacker. If an attacker attempts to execute the attack described for all possible points whose x coordinates match the output fragments, the number of possible point sequences increases exponentially with the number of iterations and quickly becomes inefficient. In order to ward off the attack described it is already sufficient in practice if some bits of a coordinate of the result are truncated and only a few continuations to x coordinates of points are possible.

Accordingly, as well as data reduction the method according to various embodiments additionally offers the advantage that implicit protection against the static Diffie-Hellman attack is achieved. Owing to the fact that an attacker can no longer iterate the calculations of the oracle, the attack described is also no longer possible. In particular there is no necessity to use elliptic curves whose orders have strong prime numbers.

What is claimed is:

1. A method for encrypted data exchange between users of a communication system using cryptography based on elliptic curves, wherein in response to a challenge of a first user a result of a first scalar multiplication is calculated by the second user, the method comprising:
determining a function value from the result of the scalar multiplication with the aid of a non-injective mapping so that the function value permits no unequivocal deduction to be made about the result, and
sending the function value back as the response to the first user.

2. The method according to claim 1, wherein
a part of the result of the scalar multiplication is determined as the function value and sent back as the response to the first user,
wherein the response contains an x coordinate of a point on the elliptic curve, and
wherein only a part of the x coordinate contained in the response is sent.

3. The method according to claim 1, wherein
a part of the result of the scalar multiplication is determined as the function value and sent back as the response to the first user,
wherein the response contains a y coordinate of a point on the elliptic curve, and
wherein only a part of the y coordinate contained in the response is sent.

4. The method according to claim 1, wherein
the challenge contains the x coordinate of a point on the elliptic curve.

5. The method according to claim 1,
the coordinates are present in binary form.

6. The method according to claim 1, wherein
the x or y coordinate of the point on the elliptic curve contained in at least one of the challenge and/or the response is present in a projective representation.

7. The method according to claim 1, wherein
the coordinate of the point in binary representation is a number containing a first and a second value which can be represented arrayed in series in a binary representation.

8. The method according to claim 7, wherein
only part of the bits of at least one of the two values are sent back.

9. The method according to claim 7, wherein
half of the bits of at least one of the two values are sent back.

10. The method according to claim 7, wherein
referred to the MSB bit, an upper bit range of the bits or an upper half of the bits of at least one of the two values, is sent back.

11. The method according to claim 1, wherein
the first user checks the response received from the second user to verify its authenticity.

12. The method according to claim 1, wherein
the first user checks whether the data contained in the response and the data of the result of a second scalar multiplication are coordinates of the same point.

13. The method according to claim 1, wherein
the first user compares the data contained in the response with a result of a second scalar multiplication, and in that the first user accepts the second user as authentic provided corresponding data of the response and of the result of the second scalar multiplication match one another.

14. The method according to claim 13, wherein
only those parts of the result of the second scalar multiplication that correspond to the part of the response sent by the second user to the first user are used for the comparison of the data of the response with the result of the second scalar multiplication.

15. The method according to claim 1, wherein
the part of the result of the first scalar multiplication that is not transmitted back as response represents a randomly generated result which is known to at least one of the two users, preferably to both users, and which can be used as a secret key in subsequent method steps.

16. The method according to claim 1, wherein
the method is an authentication method based on a challenge-response procedure for authenticating at least one of the second user to the first user and the first user to the second user.

17. The method according to claim 1, wherein
the challenge of the first user is independent of the key of the second user.

18. The method according to claim a, wherein
an elliptic curve suitable for cryptographic methods and an affine x coordinate of a base point of the elliptic curve and a public key for signature verification are provided as system parameters of the communication system.

19. The method according to claim 1, wherein
only a key known to the second user and a certificate of the second user are provided as parameters of the second user.

20. The method according to claim 18, wherein
the certificate of the second user is transmitted together with the response by the second user, a validity check of said certificate being performed in the first user using a public key known to both users.

21. A communication system for authenticating the users of the communication system using a cryptographic method based on elliptic curves, wherein in response to a challenge of a first user a result of a first scalar multiplication is calculated by the second user, wherein the system is configured:
to determine a function value from the result of the scalar multiplication with the aid of a non-injective mapping so that the function value permits no unequivocal deduction to be made about the result, and
to send the function value back as the response to the first user.

22. The system according to claim 21, wherein
a first user and at least one second user are provided, connected to one another by a data communications link, the first and second user each having an authentication module for authentication purposes.

23. The system according to claim 22, wherein
the authentication module of a respective user has a computing device that is provided for performing calculations, checks and authentications within the respective authentication module.

24. The system according to claim 21, wherein
each user has a memory in which the system parameters and the parameters individually associated with said user are stored.

25. The system according to claim 21, wherein
the first and second users are communication entities of the communication system of or a communication system embodied as an RFID system.

26. The system according to claim 21, wherein
the first user is a base station and the second user is a transponder, in particular wherein the transponder can be a passive or semi-passive or active transponder.
